(19) United States
(12) Patent Application Publication
(10) Pub. No.: US 2022/0067246 A1
(43) Pub. Date: Mar. 3, 2022

(54) SIMULATION METHOD AND SYSTEM

(71) Applicant: FUJITSU LIMITED, Kawasaki-shi (JP)

(72) Inventors: AMIR HADERBACHE, Kawasaki (JP); Koichi SHIRAHATA, Yokohama (JP)

(73) Assignee: FUJITSU LIMITED, Kawasaki-shi (JP)

(21) Appl. No.: 17/326,391

(22) Filed: May 21, 2021

(30) Foreign Application Priority Data
Sep. 1, 2020 (JP) 2020-146611

(51) Int. Cl. G06F 30/27; G06F 30/12

(52) U.S. Cl. CPC G06F 30/27; G06F 2111/02; G06F 30/12

(57) ABSTRACT

A processor acquires mesh data representing a shape of an object with a plurality of nodes and result data representing a physical amount of the object, the physical amount having been calculated based on the mesh data. The processor calculates a first feature amount representing a feature of a positional relationship of the plurality of nodes by performing a topological data analysis on the plurality of nodes included in the mesh data. The processor predicts a physical amount calculated from the shape of the object represented with more nodes than the nodes of the mesh data by entering the first feature amount and a second feature amount based on the physical amount represented by the result data to a learned model.

### CROSS-REFERENCE TO RELATED APPLICATION

This application is based upon and claims the benefit of priority of the prior Japanese Patent Application No. 2020-146611, filed on Sep. 1, 2020, the entire contents of which are incorporated herein by reference.

### FIELD

The embodiments discussed herein relate to a simulation method and a simulation system.

### BACKGROUND

A structural analysis is performed to calculate physical amounts, such as a stress and displacement, of an object from the shape of the object. In a structural analysis simulation using a computer, there are cases where a numerical analysis algorithm such as a finite element method (FEM) is used to approximately obtain a solution to a governing equation representing a physical phenomenon. In such a structural analysis simulation, there are cases where mesh data including discrete nodes and an individual edge between every two nodes is used as shape data representing the shape of an object.

In addition, there has been proposed a stress concentration analysis system in which a basic shape such as a fillet is extracted from shape data, a database is searched for a stress concentration factor corresponding to the size of the extracted basic shape, and a stress is calculated by using the retrieved stress concentration factor. There has also been proposed a leakage determination system in which a measuring error is converted into coordinate information, a feature vector is calculated from the coordinate information through a topological data analysis (TDA), and leakage of the liquid in a tank is detected by entering the feature vector to a neural network. See the following literatures, for example.

Japanese Laid-open Patent Publication No. 2007-304739

Japanese Laid-open Patent Publication No. 2019-210053

In a structural analysis simulation, an accurate analysis result is obtained by using fine mesh data including many nodes. However, preparing fine mesh data is a heavy burden on the user. In addition, use of fine mesh data results in a large calculation amount in the simulation, thereby extending the execution time.

A solution to this problem is a method in which a structural analysis simulation is performed by using coarse mesh data including a smaller number of nodes and in which an analysis result corresponding to that obtained by using fine mesh data is predicted from the execution result of the structural analysis simulation. To predict such an analysis result, a learned model such as a neural network generated by machine learning could be used. The learned model predicts accurate physical amounts from feature amounts relating to the coarse simulation.

However, what feature amounts need to be used as the input for the learned model is a problem. Depending on the feature amounts used, the user may need to manually analyze various kinds of information and create the input data for the learned model. It is unrealistic for the user to manually create the input data per critical portion such as a corner or a hole for which accurate physical amounts need to be calculated. Thus, it could practically be difficult to predict an accurate analysis result by using a learned model.

### SUMMARY

According to an aspect, there is provided a non-transitory computer-readable recording medium storing therein a computer program that causes a computer to execute a process including: acquiring mesh data representing a shape of an object with a plurality of nodes and result data representing a physical amount of the object, the physical amount having been calculated based on the mesh data; calculating a first feature amount representing a feature of a positional relationship of the plurality of nodes by performing a topological data analysis on the plurality of nodes included in the mesh data; and predicting a physical amount calculated from the shape of the object represented with more nodes than the nodes of the mesh data by entering the first feature amount and a second feature amount based on the physical amount represented by the result data to a learned model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a simulation system according to a first embodiment;

FIG. 2 illustrates an example of a simulation system according to a second embodiment;

FIG. 3 is a block diagram illustrating a hardware example of a simulation server;

FIG. 4 illustrates an example of a part on which a stress analysis is performed;

FIG. 5 illustrates an example of a method for predicting a stress on a fillet;

FIG. 6 illustrates an example of a method for generating input data for a predictor;

FIG. 7 illustrates a first example of vector representation of a topological data analysis;

FIG. 8 illustrates a second example of vector representation of the topological data analysis;

FIG. 9 illustrates an example of a method for detecting a corner from a stress distribution;

FIG. 10 illustrates a structural example of a neural network;

FIG. 11 illustrates an example of a shape model for generating training data;

FIG. 12 is a block diagram illustrating a functional example of the simulation system;

FIG. 13 is a flowchart illustrating an example of a procedure of machine learning;

FIG. 14 is a flowchart illustrating an example of the first half of a procedure of a simulation;

FIG. 15 is a flowchart illustrating an example of the second half of the procedure of the simulation; and

FIG. 16 is a graph illustrating an example of improvement in the speed of the simulation.

### DESCRIPTION OF EMBODIMENTS

Hereinafter, embodiments will be described with reference to the accompanying drawings.

### First Embodiment

A first embodiment will be described.

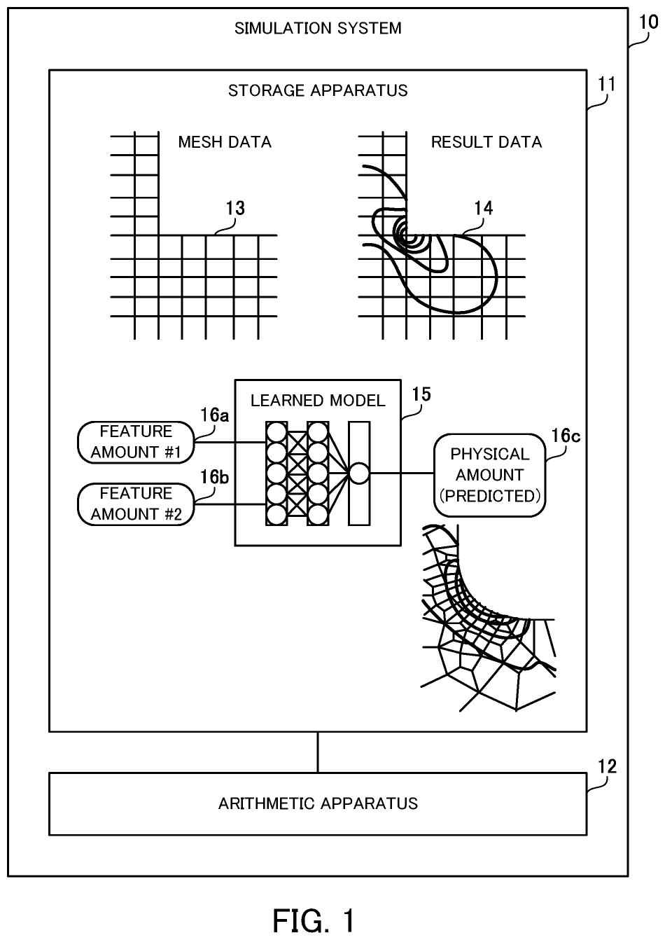

FIG. 1 illustrates a simulation system according to a first embodiment.

This simulation system 10 performs a structural analysis simulation for analyzing physical characteristics of an object from a shape of the object. The simulation system 10 may be a single computer or a group of computers. The individual computer may be a client computer or a server computer.

The simulation system 10 includes a storage apparatus 11 and an arithmetic apparatus 12. The storage apparatus 11 may include a volatile semiconductor memory such as a random access memory (RAM) or a non-volatile storage such as a hard disk drive (HDD) or a flash memory. The arithmetic apparatus 12 may include a processor such as a central processing unit (CPU), a graphics processing unit (GPU), or a digital signal processor (DSP). In addition, the arithmetic apparatus 12 may include an electronic circuit for specific use, such as an application specific integrated circuit (ASIC) or a field programmable gate array (FPGA). The processor executes programs stored in a memory such as a RAM. A plurality of processors will be referred to as a “multi-processor” or simply a “processor”, as needed.

The storage apparatus 11 holds mesh data 13. The mesh data 13 represents a shape of an object by using a plurality of discrete nodes. The object may be an industrial part having a hole or a complex outer edge. The object may have a two-dimensional shape or a three-dimensional shape. The mesh data 13 may be a finite element model obtained by dividing the space including the object into “elements”, which are small areas, each of which is surrounded by nodes and edges around the nodes.

Each element has a predetermined kind of shape, such as a triangle, a rectangle, a tetrahedron, or a cube. It is preferable that the elements included in the mesh data 13 have approximately the same size (mesh size).

The mesh data 13 is simple mesh data in which the density of the nodes is relatively low. That is, the number of nodes is relatively small. Thus, the mesh data 13 does not accurately represent the shape of the object to be analyzed. For example, while the object actually has a round corner referred to as a fillet, the mesh data 13 may simply define this fillet as a sharp corner having a vertex such as a right angle. This is because many nodes are needed to represent a curve.

In addition, the storage apparatus 11 holds result data 14. The result data 14 represents a physical amount of the object calculated based on the mesh data 13. Examples of the physical amount include a stress, a displacement, a voltage, and an electromagnetic potential. The result data 14 may be an execution result of a finite element method using the mesh data 13. A physical amount may be calculated for each of the plurality of nodes. For example, a variable is assigned to each of the plurality of nodes, and based on a governing equation indicating a physical phenomenon, a coefficient matrix indicating a relationship among the plurality of variables is generated. Based on the coefficient matrix, a matrix operation in accordance with an iterative method for obtaining an approximate solution to a simultaneous equation is performed. However, since the mesh data 13 is simple mesh data including a smaller number of nodes, the physical amount represented by the result data 14 is not an accurate simulation result.

The arithmetic apparatus 12 calculates a feature amount 16a by performing a topological data analysis on the plurality of nodes included in the mesh data 13. The feature amount 16a represents a feature of a positional relationship of the plurality of nodes. The feature amount 16a reflects a feature of the shape such as the size of a hole or the angle of a corner indicated by the mesh data 13. The topological data analysis may be persistent homology. The feature amount 16a may be a feature vector in which a radius r of an individual node and a Betti number are associated with each other. The feature amount 16a may be about a 2000-dimensional vector.

In the topological data analysis, for example, each node included in the mesh data 13 is considered as a particle having the radius r (a two-dimensional circle or a three-dimensional sphere). When the radius r is small, since neighboring nodes do not have an overlapping region, a closed region surrounded by a plurality of nodes is not created in the space. When the radius r is increased, since neighboring nodes have an overlapping region, and a closed region surrounded by a plurality of nodes could be created in the space. When the radius r is further increased, since each node has an overlapping region with many other nodes, the above closed region is reduced and disappears. Thus, occurrence and disappearance of an individual closed region and the number of existing closed regions are each a function of the radius r. In the topological data analysis, a relationship between the radius r and the closed regions is extracted. The feature amount 16a is calculated by, for example, vectorizing the relationship between the radius r and the closed regions.

In addition, the arithmetic apparatus 12 calculates a feature amount 16b based on the physical amount indicated by the result data 14. The feature amount 16b may be a statistical amount of physical amounts calculated from the mesh data 13, such as a maximum value, a minimum value, an average, a ratio of the physical amounts included in a certain region. The certain region may be a critical portion such as a hole or a corner of the object, for which an accurate physical amount needs to be calculated. The arithmetic apparatus 12 may detect a critical portion based on a distribution of physical amounts. The arithmetic apparatus 12 may use a learned model, such as a neural network, to determine whether a target region is a critical portion from a distribution pattern of physical amounts.

For example, from the result data 14 representing the physical amounts of the nodes, the arithmetic apparatus 12 generates a bitmap representing physical amounts at grid points through linear interpolation. The arithmetic apparatus 12 extracts an area from the bitmap by using a sliding window and enters the physical amounts included in the extracted region to a convolutional neural network. Based on the group of physical amounts entered, the convolutional neural network outputs a flag indicating whether the extracted region is a critical portion such as a corner.

The arithmetic apparatus 12 enters the feature amounts 16a and 16b to a learned model 15, to predict a physical amount 16c. The physical amount 16c is a physical amount calculated from the shape of the object represented by using more nodes than the nodes of the mesh data 13. That is, the physical amount 16c is a physical amount calculated from fine mesh data having a higher node density and more nodes than those of the mesh data 13. The fine mesh data accurately represents the shape of the object. As described above, while the object actually includes a fillet, the mesh data 13 represents this fillet as a sharp corner having, for example, a right angle. For example, the physical amount 16c represents the stress on this fillet.

The learned model 15 may be a neural network. The learned model 15 may receive input data in a tensor form including the feature amounts 16a and 16b. The input data may be a column vector in which the feature amounts 16a and 16b are combined. The learned model 15 is generated in advance through machine learning. The simulation system 10 may generate the learned model 15.

For example, the simulation system 10 generates course mesh data, performs a topological data analysis on the course mesh data, and calculates a first feature amount. In addition, the simulation system 10 executes a finite element method by using the course mesh data, to calculate a second feature amount. In addition, the simulation system 10 generates fine mesh data, performs a finite element method by using the fine mesh data, and generates teaching data indicating correct physical amounts. In this way, training data is generated. The simulation system 10 generates the learned model 15 by using the training data.

The simulation system 10 according to the first embodiment generates the feature amount 16a representing a feature of a positional relationship of nodes from the mesh data 13 through a topological data analysis. Next, the feature amount 16b based on the result data 14 is entered to the learned model 15 along with the feature amount 16a, and the physical amount 16c, which would have been calculated if fine mesh data had been used in place of the mesh data 13, is predicted. For example, from the feature amount 16a corresponding to the mesh data 13 in which a sharp corner is represented and the feature amount 16b in which the stress on the sharp corner is represented, the stress on the fillet corresponding to the corner is predicted.

In this way, compared with a simulation using fine mesh data, the burden of creating mesh data is reduced. In addition, since the calculation amount of the simulation is reduced, the execution time is shortened. In addition, the accuracy of the analysis result is maintained. In addition, from the result of the simulation using the coarse mesh data, the feature amounts 16a and 16b for predicting the physical amount 16c are automatically extracted. Thus, the user does not need to create the input data manually, and the physical amount 16c is predicated more effectively by using the learned model 15. In addition, by performing a topological data analysis, the feature of the shape represented by the mesh data 13 is appropriately reflected on the feature amount 16a. Thus, the prediction accuracy of the learned model 15 is improved.

### Second Embodiment

Next, a second embodiment will be described.

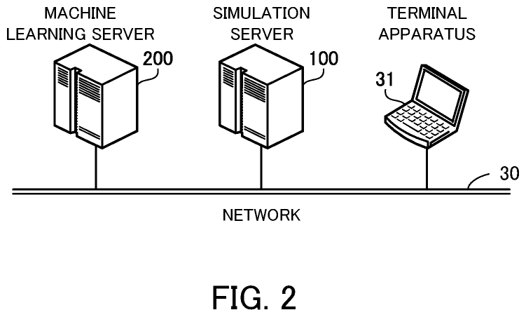

FIG. 2 illustrates an example of a simulation system according to a second embodiment.

This simulation system according to the second embodiment calculates a stress distribution based on a shape of an object by performing a structural analysis simulation based on a finite element method. This simulation system is used for designing an industrial part, for example. This simulation system includes a terminal apparatus 31, a simulation server 100, and a machine learning server 200. These apparatuses are connected to a network 30. The network 30 may include a local area network (LAN) or the Internet.

The terminal apparatus 31 is a client computer used by a user. The terminal apparatus 31 accesses the simulation server 100 and causes it to perform a structural analysis simulation. The terminal apparatus 31 receives an analysis result from the simulation server 100 and displays the received analysis result.

The simulation server 100 is a server computer that performs a structural analysis simulation based on a finite element method. The simulation server 100 may be installed at a data center and may provide so-called cloud services. The simulation server 100 may use a learned neural network in the structural analysis simulation. The simulation server 100 acquires the learned neural network from the machine learning server 200.

The machine learning server 200 is a server computer that performs machine learning. The machine learning server 200 may be installed at a data center and may provide so-called cloud services. The machine learning server 200 acquires training data and generates a neural network used in the structural analysis simulation through machine learning. The learned neural network is provided to the simulation server 100. The structural analysis simulation and the machine learning may be performed in a single apparatus.

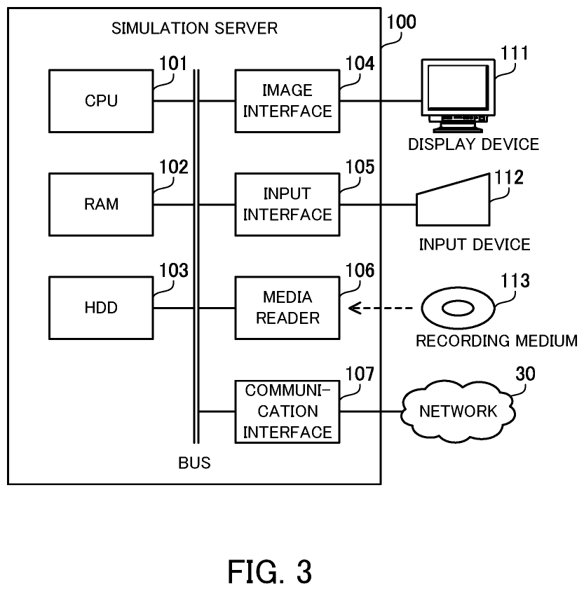

FIG. 3 is a block diagram illustrating a hardware example of the simulation server 100.

The simulation server 100 includes a CPU 101, a RAM 102, an HDD 103, an image interface 104, an input interface 105, a media reader 106, and a communication interface 107. These units included in the simulation server 100 are connected to a bus. The CPU 101 corresponds to the arithmetic apparatus 12 according to the first embodiment. The RAM 102 or the HDD 103 corresponds to the storage apparatus 11 according to the first embodiment. The terminal apparatus 31 and the machine learning server 200 also include like hardware components.

The CPU 101 is a processor that executes program commands. The CPU 101 loads a program or at least part of the data stored in the HDD 103 to the RAM 102 and executes the program. The CPU 101 may include a plurality of processor cores, and the simulation server 100 may include a plurality of processors. A group of processors may be referred to as “a multiprocessor” or simply “a processor”.

The RAM 102 is a volatile semiconductor memory in which the program executed by the CPU 101 or the data used by the CPU 101 for calculation is temporarily stored. The simulation server 100 may include a different kind of memory other than a RAM or may include a plurality of memories.

The HDD 103 is a non-volatile storage that holds an operating system (OS), middleware, software programs such as application software, and data. The simulation server 100 may include a different kind of storage such as a flash memory or a solid state drive (SSD). The simulation server 100 may include a plurality of storages.

The image interface 104 outputs an image to a display device 111 connected to the simulation server 100 in accordance with a command from the CPU 101. Any kind of display device such as a cathode ray tube (CRT) display, a liquid crystal display (LCD), an organic electro-luminescence (OEL) display, or a projector may be used as the display device 111. Other than the display device 111, an output device such as a printer may be connected to the simulation server 100.

The input interface 105 receives an input signal from an input device 112 connected to the simulation server 100. Any kind of input device such as a mouse, a touch panel, a touchpad, or a keyboard may be used as the input device 112. A plurality of kinds of input devices may be connected to the simulation server 100.

The media reader 106 is a reading device that reads a program or data recorded in a recording medium 113. Any kind of recording medium such as a magnetic disk such as a flexible disk (FD) or an HDD, an optical disc such as a compact disc (CD) or a digital versatile disc (DVD), or a semiconductor memory may be used as the recording medium 113. The media reader 106 copies, for example, a program or data read from the recording medium 113 to another recording medium such as the RAM 102 or the HDD 103. The read program is executed by the CPU 101, for example. The recording medium 113 may be a portable recording medium and may be used to distribute a program or data. In addition, the recording medium 113 or the HDD 103 may be referred to as a computer-readable recording medium.

The communication interface 107 is connected to the network 30 and communicates with the terminal apparatus 31 or the machine learning server 200 via the network 30. The communication interface 107 may be a wired communication interface connected to a wired communication apparatus such as a switch or a router. Alternatively, the communication interface 107 may be a wireless communication interface connected to a wireless communication apparatus such as a base station or an access point.

Next, a procedure of a stress analysis will be described.

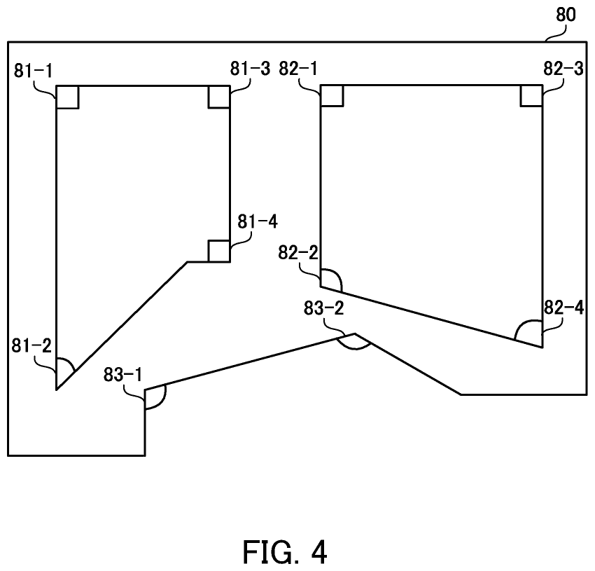

FIG. 4 illustrates an example of a part on which a stress analysis is performed.

A part 80 is an example of an object on which a stress analysis is performed. The part 80 may be an industrial part or a metal part being designed. The part 80 has a hole having corners 81-1, 81-2, 81-3, and 81-4 and a hole having corners 82-1, 82-2, 82-3, and 82-4. In addition, the part 80 has a notch having corners 83-1 and 83-2. The outer angles of the above 10 corners of this member are larger than 0 degree and smaller than 180 degrees. The angle of each of the corners 81-1, 81-3, 81-4, 82-1, and 82-3 is 90 degrees. The angle of the corner 81-2 is 45 degrees. The angle of each of the corners 82-2 and 83-1 is 120 degrees. The angle of the corner 82-4 is 60 degrees, and the angle of the corner 83-2 is 150 degrees.

Each of the above 10 corners is a sharp corner having a vertex in FIG. 4. In the second embodiment, a sharp corner having a vertex with an angle between 0 degree and 180 degrees will be referred to as a “corner”, as needed. When force is externally applied to the part 80, stress concentration could occur. The stress concentration is a phenomenon in which a certain portion has a significantly larger stress than other portions. In the example in FIG. 4, the stress between a portion around the corner 83-1 and a portion around the corner 82-1 could become large. If such force continues to be applied externally to the part 80, the part 80 could consequently be broken into pieces.

Thus, when the part 80 is designed, the above 10 corners need to be defined as fillets to reduce the stress concentration. A fillet is a smooth corner that does not have a vertex but has a curve with a predetermined curvature radius. Since a fillet is used in place of a corner, a less stress is imposed on the fillet than the stress imposed on a portion around the corner. The simulation server 100 calculates a stress distribution of the object by performing a structural analysis simulation on the individual parts including fillets. As a result, information useful in designing the part is provided.

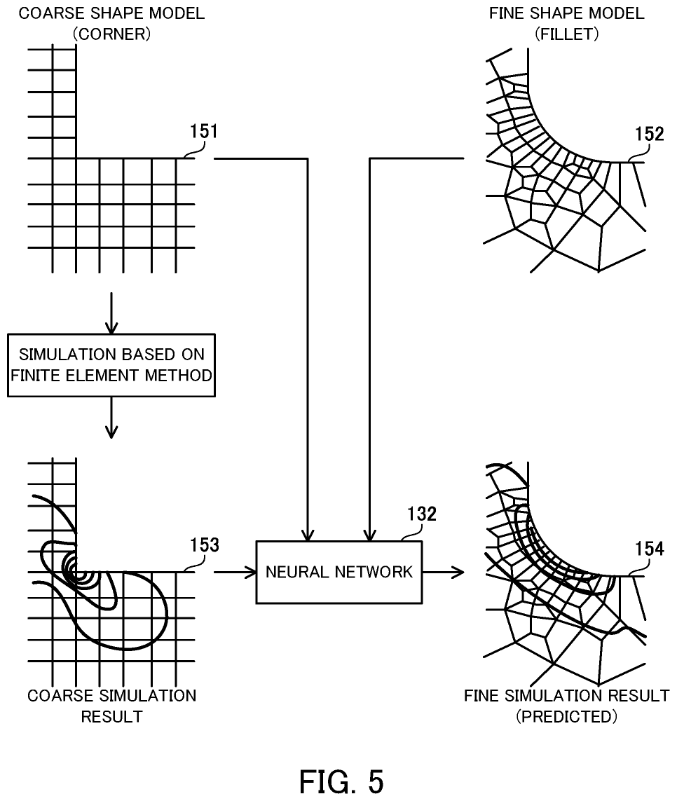

FIG. 5 illustrates an example of a method for predicting the stress on a fillet.

As a method for calculating the stress on a fillet, a fine shape model 152 accurately representing the shape of the fillet may be created, and a simulation based on a finite element method may be performed by using the fine shape model 152. A model used for the finite element method is a mesh model representing by the shape of the target object with a mesh. The mesh model includes a plurality of nodes and edges around the nodes, the space including the object is divided into elements, which are small areas, each of which is surrounded by nodes and edges. The elements have a predetermined shape such as a triangle, a rectangle, a tetrahedron, or a hexahedron, for example.

To represent a curve, the fine shape model 152 includes many elements having a small mesh size and includes many nodes. Thus, generating the fine shape model 152 from computer-aided design (CAD) data is a heavy burden. In addition, if a simulation based on a finite element method is performed on the fine shape model 152 having many nodes, the calculation amount of the simulation becomes large, and the execution time is extended. Therefore, the simulation server 100 calculates the stress on a fillet in accordance with the following procedure.

First, a coarse shape model 151 is generated from CAD data. The simulation server 100 or another apparatus may generate the coarse shape model 151. The mesh size of the coarse shape model 151 is larger than that of the fine shape model 152, and the number of nodes of the coarse shape model 151 is less than that of the fine shape model 152. Thus, with the coarse shape model 151, it is difficult to accurately represent curves. For this reason, the coarse shape model 151 represents a fillet as a corner.

The simulation server 100 performs a simulation based on a finite element method on the coarse shape model 151 and generates a coarse simulation result 153. For example, the simulation server 100 assigns a variable to an individual node of the coarse shape model 151 and generates a coefficient matrix indicating an inter-node relationship based on a governing equation indicating a physical law relating to stress. The simulation server 100 obtains a solution to a simultaneous equation in accordance with an iterative method by using the coefficient matrix. The coarse simulation result 153 indicates the stress on a portion around an individual corner.

The simulation server 100 generates input data for a neural network 132 generated in advance through machine learning. The neural network 132 is a multi-layer neural network including an input layer, an intermediate layer, and an output layer. The input data is a tensor including a feature amount about the stress indicated by the coarse simulation result 153, a feature amount about the shape indicated by the coarse shape model 151, and a feature amount about a fillet. The neural network 132 outputs the stress on a portion around a fillet. In this way, a fine simulation result 154 indicating a predicated stress on a fillet is generated.

The fine simulation result 154 indicates a predicted stress on a fillet, which would have been calculated if a simulation based on a finite element method had been executed by using the fine shape model 152. Thus, the fine simulation result 154 indicates a more accurate stress distribution of an object including fillets than the coarse simulation result 153. However, the burden of creating the coarse shape model 151 is lighter than that of creating the fine shape model 152, and the calculation amount of the simulation based on a finite element method using the coarse shape model 151 is less than that using the fine shape model 152. In addition, the calculation amount for the prediction using the neural network 132 is sufficiently small. Thus, the execution time of the structural analysis simulation is shorter than that of a structural analysis simulation using the fine shape model 152.

In the present embodiment, accurate stresses may be calculated only for the critical portions such as corners and holes where stress concentration easily occurs. For the stresses on the locations other than these critical portions, the stresses calculated from the coarse shape model 151 may be adopted. In this case, the simulation server 100 calculates a stress distribution of a whole object by using the coarse shape model 151 and converts the stresses on the corners of the whole object into those on the fillets by using the neural network 132. The neural network 132 outputs a predicted stress on a single fillet.

When preparing input data for the neural network 132 per corner, the user may determine the corners one by one from the coarse shape model 151 and manually collect a feature amount about an individual corner.

However, if the object includes many corners, since it takes time and effort to manually create the input data, this method is unrealistic.

Thus, the simulation server 100 efficiently extracts various kinds of feature amounts from the coarse shape model 151 and the coarse simulation result 153. In the second embodiment, the simulation server 100 extracts the feature amounts about the shape of the coarse shape model 151 by using persistent homology of a topological data analysis. In addition, the simulation server 100 automatically detects and extracts a feature amount about a stress on a corner by using a sliding window on the coarse simulation result 153.

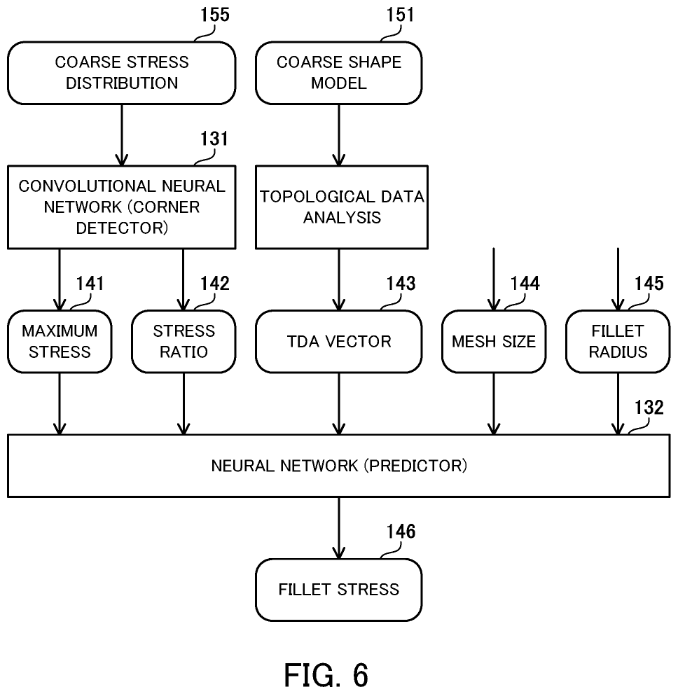

FIG. 6 illustrates an example of a method for generating input data for a predictor.

The input data for the neural network 132 serving as a predictor includes a maximum stress 141, a stress ratio 142, a TDA vector 143, a mesh size 144, and a fillet radius 145. The maximum stress 141 is the maximum value of the stress in a predetermined region having the vertex of a corner as its center. The stress ratio 142 is the ratio between the magnitudes of the stresses in different directions from the vertex of the corner. For example, the stress ratio 142 is the ratio between the magnitude of the stress in a horizontal direction at a first location around the corner and the magnitude of the stress in a vertical direction at a second location opposite to the first location over the vertex of the corner.

The TDA vector 143 is a feature vector representing features of the shape represented by the coarse shape model 151. The TDA vector 143 reflects geometry features such as the angle of a corner and the diameter of a hole. The mesh size 144 is the size of the mesh of the coarse shape model 151. The fillet radius 145 is the curvature radius of a fillet that replaces the corner. All the corners may have the same fillet radius 145. The mesh size 144 and the fillet radius 145 are inputted by the user.

The simulation server 100 generates a coarse stress distribution 155, which is a bitmap, from the coarse simulation result 153. The coarse stress distribution 155 represents the stresses on the grid points of an orthogonal grid. The simulation server 100 generates the coarse stress distribution 155 representing the stresses on the grid points through linear interpolation or the like from the coarse simulation result 153 representing the stresses on the nodes. The coarse stress distribution 155 may be considered as a two-dimensional image or a second-order tensor.

The simulation server 100 extracts a square area from the coarse stress distribution 155 by using a sliding window and enters a stress distribution in the extracted square area to a convolutional neural network 131 serving as a corner detector. The convolutional neural network 131 is a multi-layer neural network including a convolution operation, which is a multiply-accumulate operation on a tensor. The convolutional neural network 131 is generated in advance through machine learning.

The convolutional neural network 131 determines, from a stress distribution in a square area, whether the square area includes a corner. In the convolutional neural network 131, the tendency of a stress distribution corresponding to a corner has been learned. The convolutional neural network 131 outputs a corner flag indicating whether the square area includes a corner and the maximum stress 141 and the stress ratio 142 in the square area. If the corner flag in the square area is ON, the stress on the corresponding fillet is predicted by using the neural network 132.

In addition, the simulation server 100 generates the TDA vector 143 by performing a topological data analysis on the coarse shape model 151. The TDA vector 143 is obtained by converting the result of persistent homology into vector representation. The TDA vector 143 is, for example, a 2000-dimensional column vector. The topological data analysis will be described below. A single maximum stress 141 and a single stress ratio 142 are calculated per corner. A single TDA vector 143 is generated from the entire coarse shape model 151.

The simulation server 100 generates input data in which the maximum stress 141, the stress ratio 142, the TDA vector 143, the mesh size 144, and the fillet radius 145 are combined with each other, per corner detected by the convolutional neural network 131. The input data is, for example, a 2004-dimensional vector. The simulation server 100 enters the input data to the neural network 132 to calculate a fillet stress 146. The fillet stress 146 represents the stress on a fillet.

Next, the topological data analysis will be described.

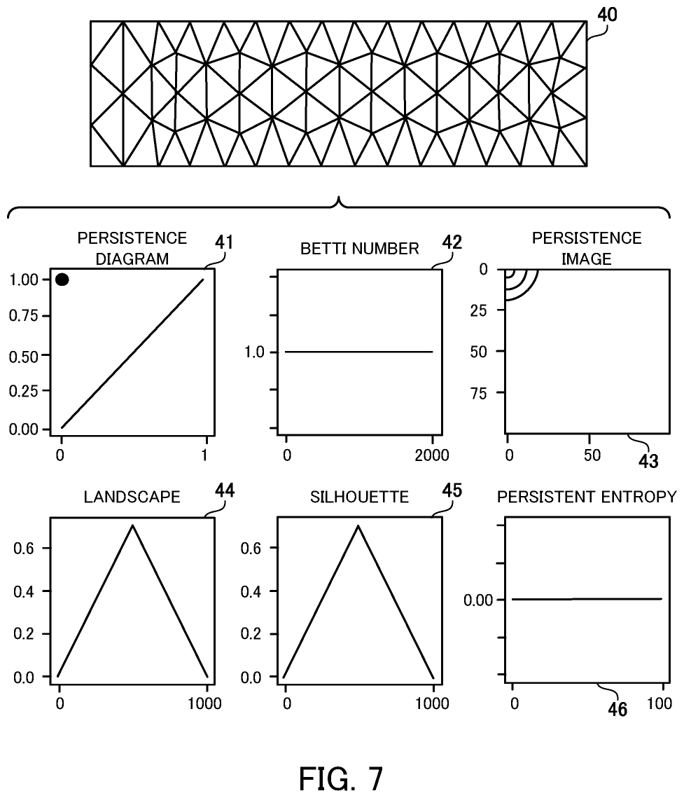

FIG. 7 illustrates a first example of vector representation of a topological data analysis.

In the topological data analysis, a feature of a positional relationship of a plurality of nodes is extracted. In the topological data analysis, each node is considered as a particle having the radius r. When the radius r is small, since neighboring nodes do not come into contact with each other, a closed region surrounded by a plurality of nodes is not created. When the radius r is increased, since neighboring nodes come into contact with each other, a closed region could be created. When the radius r is further increased, since each node has an overlapping region with many other nodes, the above closed region is reduced and disappears. Thus, occurrence and disappearance of an individual closed region are each represented as a function of the radius r.

When a topological data analysis is performed on a shape model 40, the analysis result could be represented in different representation forms such as graphs 41 to 46. The graph 41 is a persistence diagram. The horizontal axis of the graph 41 represents a radius b corresponding to when a closed region appears, and the vertical axis of the graph 41 represents a radius d corresponding to when the closed region disappears. In the graph 41, a single point is plotted for a single closed region. An individual point in the graph 41 is plotted on the upper side of a straight line (d=b) due to its nature. A point around the straight line (d=b) corresponds to a closed region that exists only for a short time and is a noise that does not represent a geometry feature of the shape model 40. In contrast, a point away from the straight line (d=b) corresponds to a closed region that exists for a long time and represents a geometry feature of the shape model 40.

The graph 42 represents a Betti curve. The horizontal axis of the graph 42 represents the radius r, and the vertical axis of the graph 42 represents a Betti number. The Betti number is the number of closed regions that exist when the node radius is r. The graph 43 is a persistence image. The horizontal axis of the graph 43 represents the radius b, and the vertical axis of the graph 43 represents a probability density of an absolute value of the difference between the radius d and the radius b (|d-b|). The graph 43 is generated from the graph 41, assuming that the probability density is in accord with a Gaussian distribution.

The graph 44 represents a landscape. The landscape is calculated as follows. As expressed by an expression (1), a function Λ(t) having a variable t is defined for a point n in the persistence diagram. The function Λ(t) is defined by using the radius b corresponding to when a closed region appears and the radius d corresponding to when the closed region disappears. In addition, as expressed by an expression (2), a function L(t) indicating a maximum value of Λ(t) among all the points is defined. The function L(t) is the landscape. The horizontal axis of the graph 44 represents t, and the vertical axis of the graph 44 represents L(t).

$$\begin{matrix}{Λ}_{n} ( t ) = \{ \begin{matrix}t - b & t ∈ [ b , ( b + d ) / 2 ] \\ d - t & t ∈ ( ( b + d ) / 2 , d ] \\ 0 & else\end{matrix} & ( 1 ) \\ L ( t ) = {max}_{n} {Λ}_{n} ( t ) & ( 2 )\end{matrix}$$

The graph 45 represents a silhouette. As expressed by (3), the silhouette is defined as a function φ(t) using Λ(t), b, and d. In an expression (3), p represents a parameter specified by the user. The horizontal axis of the graph 45 represents t, and the vertical axis of the graph 45 represents φ(t). The graph 46 represents a persistent entropy. The persistent entropy E is defined as expressed by an expression (4). In the expression (4), 1 represents persistence, and L represents a total persistence.

$$\begin{matrix}ϕ ( t ) = \frac{\sum \vert d - b \vert {Λ}_{n} ( t )}{\sum {\vert d - b \vert}^{P}} & ( 3 ) \\ E = - \sum \frac{L}{} log \frac{L}{} & ( 4 )\end{matrix}$$

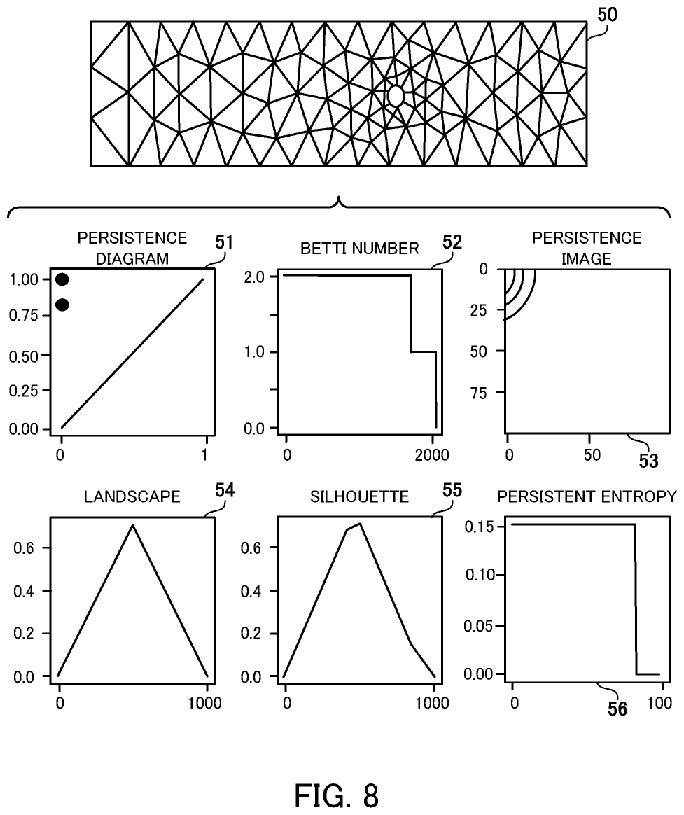

FIG. 8 illustrates a second example of vector representation of the topological data analysis.

As is the case with the shape model 40, when a topological data analysis is performed on a shape model 50, the analysis result could be represented in different representation forms such as graphs 51 to 56. The shape model 50 differs from the shape model 40 in that the shape model 50 has a hole, which is a critical portion. The graph 51 is a persistence diagram, and the graph 52 represents a Betti curve. The graph 53 represents a persistence image, and the graph 54 represents a landscape. The graph 55 represents a silhouette, and the graph 56 represents a persistent entropy.

The shape model 40 differs from the shape model 50 in that the shape model 40 has a hole. In other aspects, the shape models 40 and 50 are similar to each other in the node arrangement. However, the graphs 41 to 46 are clearly different from the graphs 51 to 56, when compared with each other. Thus, the results of both the topological data analyses, such as the graphs 41 to 46 and the graphs 51 to 56, accurately represent their respective geometry features.

In the second embodiment, the simulation server 100 vectorizes the result of the topological data analysis by using Betti numbers as illustrated in the graph 42 or 52. That is, the TDA vector 143 is defined as a vector in which Betti numbers corresponding to different radii r are listed. In the second embodiment, as represented by the horizontal axis of the graph 42 or 52, the number of dimensions of the TDA vector 143 is 2000. The TDA vector 143 is a numerical vector in which Betti numbers from r=1 to r=2000 are listed. However, the TDA vector 143 may be defined by using vector representation other than these Betti numbers.

Next, detection of a corner will be described.

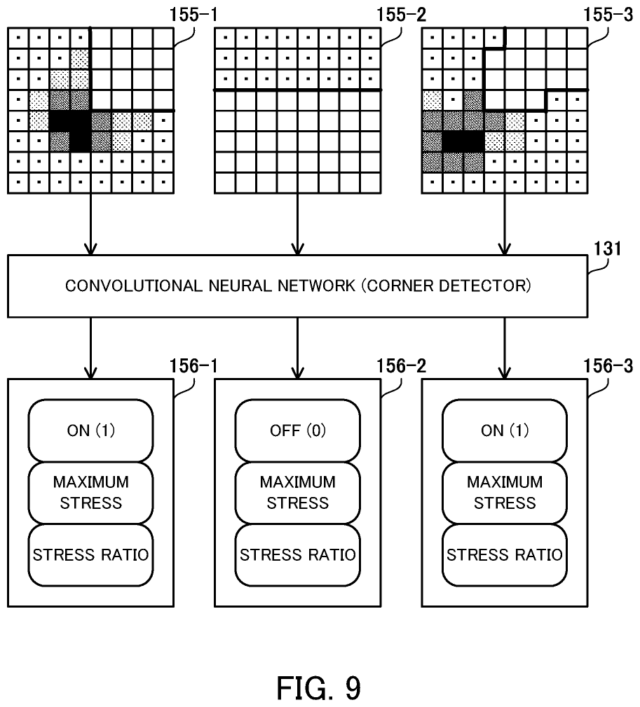

FIG. 9 illustrates an example of a method for detecting a corner from a stress distribution.

The simulation server 100 extracts square areas, such as small areas 155-1 to 155-3, by moving a sliding window having a predetermined size on the coarse stress distribution 155 corresponding to the coarse simulation result 153. The small areas 155-1 to 155-3 are each a tensor in which stress magnitudes are arranged in a grid. The simulation server 100 enters each of the small areas 155-1 to 155-3 to the convolutional neural network 131 serving as a corner detector. The convolutional neural network 131 outputs output data 156-1 to 156-3 corresponding to the small areas 155-1 to 155-3, respectively. Each of the output data 156-1 to 156-3 includes a corner flag, a maximum stress, and a stress ratio.

The corner flag included in the output data 156-1 is ON(1), indicating that the small area 155-1 includes a corner. The maximum stress included in the output data 156-1 is the maximum value of the stress in the small area 155-1. The stress ratio included in the output data 156-1 is the ratio of the stress in the vertical direction to the stress in the horizontal direction in the small area 155-1. The corner flag included in the output data 156-2 is OFF(0), indicating that the small area 155-2 does not include a corner. The corner flag included in the output data 156-3 is ON(1), indicating that the small areas 155-3 includes a corner. The maximum stress included in the output data 156-3 is the maximum value of the stress in the small area 155-3. The stress ratio included in the output data 156-3 is the ratio of the stress in the vertical direction to the stress in the horizontal direction in the small area 155-3.

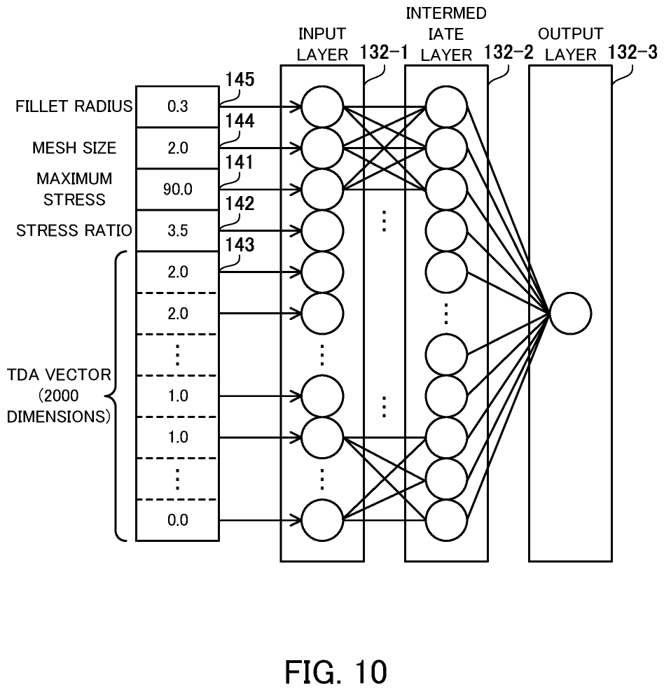

FIG. 10 illustrates a structural example of the neural network 132.

The neural network 132 serving as a predictor includes an input layer 132-1, intermediate layers 132-2, and an output layer 132-3. The neural network 132 includes a plurality of intermediate layers. The number of dimensions of the input layer 132-1 is 2004. The number of dimensions of the intermediate layers 132-2 may be the same as, smaller than, or bigger than that of the input layer 132-1. The number of dimensions of the output layer 132-3 is 1.

The 2004-dimensional input data entered to the input layer 132-1 is created by combining the fillet radius 145, the mesh size 144, the maximum stress 141, the stress ratio 142, and the TDA vector 143. When the Betti number is in accord with the graph 52 in FIG. 8, the TDA vector 143 represents a numerical sequence such as {2, 0, 2, 0, . . . , 1.0, 1.0, . . . , 0.0}. Since the number of dimensions of the TDA vector 143 is 2000, the number of dimensions of the entire input data is 2004. The number of dimensions of the TDA vector 143 may be changed.

Next, machine learning for generating the convolutional neural network 131 and the neural network 132 will be described.

Training data used by the machine learning server 200 to generate the convolutional neural network 131 is prepared. This training data includes a stress distribution in a grid as an explanatory variable and also includes a corner flag, a maximum stress, and a stress ratio as teaching data. The training data includes a plurality of samples generated by performing coarse simulations on various object shapes. The machine learning server 200 performs, for example, backpropagation to determine the values of parameters such as weights included in the convolutional neural network 131. The machine learning server 200 enters a value of an explanatory variable included in a sample to the convolutional neural network 131 and evaluates the error between the output of the convolutional neural network 131 and the teaching data included in the sample. The machine learning server 200 updates the values of the parameters so that the error will be reduced.

In addition, training data used by the machine learning server 200 to generate the neural network 132 is prepared. This training data includes a maximum stress, a stress ratio, a TDA vector, a mesh size, and a fillet radius as explanatory variables and also includes a fillet stress as teaching data. The training data includes a plurality of samples generated by performing coarse simulations and fine simulations on various object shapes.

The machine learning server 200 performs, for example, backpropagation, to determine the values of parameters such as weights included in the neural network 132. The machine learning server 200 enters a value of an explanatory variable included in a sample to the neural network 132 and evaluates the error between the output of the neural network 132 and the teaching data included in the sample. The machine learning server 200 updates the values of the parameters so that the error will be reduced.

The training data is, for example, generated based on the following shape model.

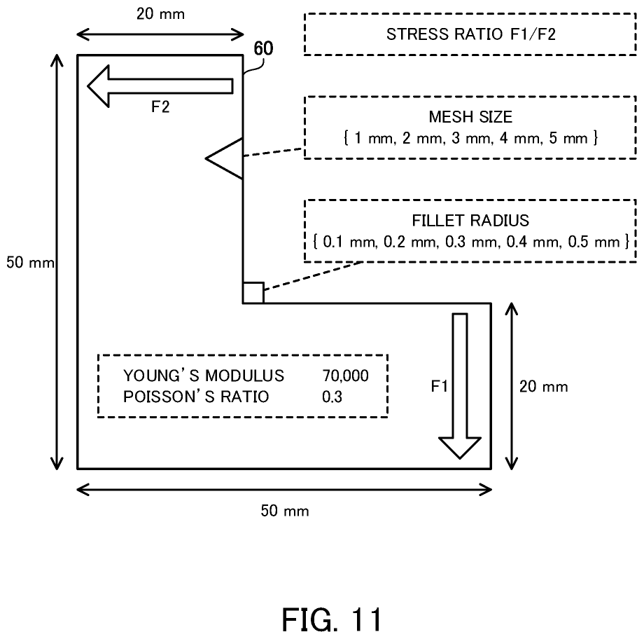

FIG. 11 illustrates an example of a shape model for generating training data.

A shape model 60 indicates a single corner. The length of the left edge of the shape model 60 is 50 millimeters (mm), and the length of the lower edge is 50 mm. The length of the upper edge is 20 mm, and the length of the right edge is 20 mm. The length between the upper edge and the vertex of the corner is 30 mm, and the length between the right edge and the vertex of the corner is 30 mm.

The angle of the individual corner is 90 degrees. However, a shape model having a corner of a different angle such as 30 degrees, 60 degrees, 120 degrees, or 150 degrees may alternatively be created. Options for the fillet radius specified for the individual corner are 0.1 mm, 0.2 mm, 0.3 mm, 0.4 mm, and 0.5 mm. One fillet radius is selected from these five options. In addition, regarding the mesh size of the shape model 60, options for the length of an edge of an element included in the shape model 60 are, 1 mm, 2 mm, 3 mm, 4 mm, and 5 mm. One mesh size is selected from these five options.

The stress ratio is represented by F1/F2. F1 represents the force applied from the upper edge to the lower edge on the right side of the corner. F2 represents the force applied from the right edge to the left edge on the upper side of the corner. The direction of the force F2 is perpendicular to that of the force F1. The stress ratio is used as a feature amount since the balance between F1 and F2 affects the stress on the vertex of the corner. One of a plurality of loading conditions is selected, and the stress ratio is determined. In addition, a Young's modulus of 70000 and a Poisson's ratio of 0.3 are adopted as material parameters indicating the elasticity of the shape model 60.

Next, functions and procedures of the simulation server 100 and the machine learning server 200 will be described.

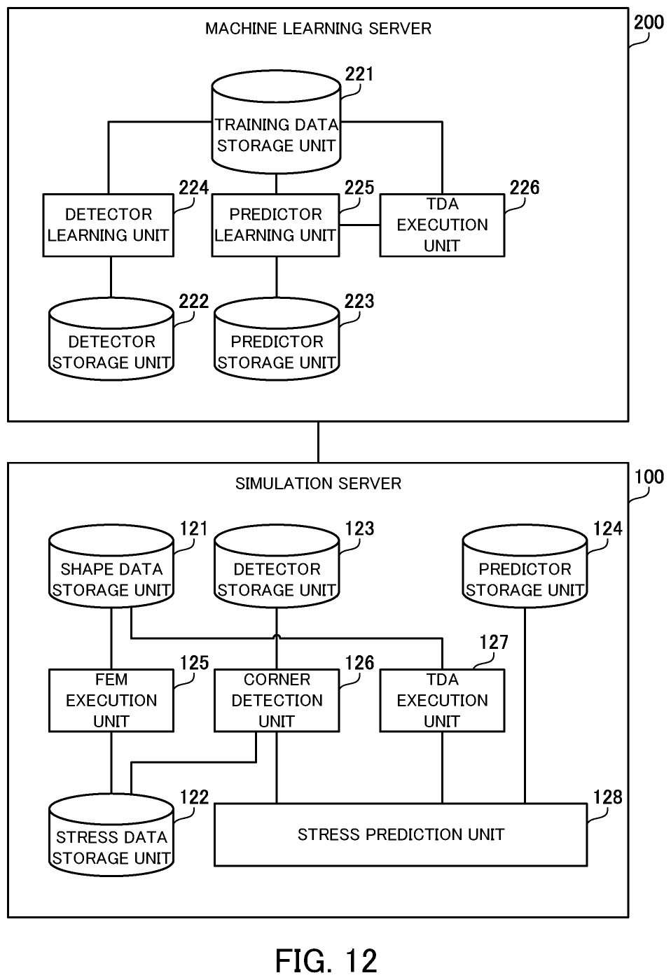

FIG. 12 is a block diagram illustrating a functional example of the simulation system.

The simulation server 100 includes a shape data storage unit 121, a stress data storage unit 122, a detector storage unit 123, and a predictor storage unit 124. These storage units are each implemented by using, for example, a storage area of the RAM 102 or the HDD 103. In addition, the simulation server 100 includes an FEM execution unit 125, a corner detection unit 126, a TDA execution unit 127, and a stress prediction unit 128. These processing units are each implemented by using, for example, a program executed by the CPU 101.

The shape data storage unit 121 holds a shape model represented by mesh data in which a region including an object is divided into many elements. The shape model stored in the shape data storage unit 121 is a coarse shape model including a smaller number of nodes. Since the coarse shape model has a large mesh size, curves such as fillets or circular holes are simply represented. The coarse shape model is generated by, for example, software for creating a mesh from CAD data representing the outline of an object. The coarse shape model may be generated by the simulation server 100. Alternatively, the coarse shape model may be generated by the terminal apparatus 31. In this case, the terminal apparatus 31 transfers the coarse shape model to the simulation server 100.

The stress data storage unit 122 holds a coarse simulation result calculated from the coarse shape model. The coarse simulation result includes a stress on each node included in the coarse shape model, for example. In addition, the stress data storage unit 122 holds a bitmap representing a stress distribution in a grid shape converted from the coarse simulation result.

The detector storage unit 123 holds a convolutional neural network serving as a corner detector generated by the machine learning server 200. The predictor storage unit 124 holds a neural network serving as a predictor generated by the machine learning server 200.

The FEM execution unit 125 executes a simulation based on a finite element method on the coarse shape model stored in the shape data storage unit 121. For example, the FEM execution unit 125 assigns a variable to an individual node included in the coarse shape model, generates a coefficient matrix representing an inter-node relationship, and obtains a solution to a simultaneous equation based on an iterative method using the coefficient matrix. The FEM execution unit 125 stores a coarse simulation result including the calculated stresses in the stress data storage unit 122.

The corner detection unit 126 converts the coarse simulation result stored in the stress data storage unit 122 into a bitmap. For example, the corner detection unit 126 estimates the stress on an individual grid point of an orthogonal grid through linear interpolation from the stress on a corresponding node. Next, the corner detection unit 126 extracts a small area from the bitmap by using a sliding window and enters a stress distribution of the extracted small area to the convolutional neural network stored in the detector storage unit 123. The corner detection unit 126 detects a corner based on a corner flag outputted by the convolutional neural network. The corner detection unit 126 outputs the maximum stress and the stress ratio of each detected corner outputted by the convolutional neural network to the stress prediction unit 128.

The TDA execution unit 127 executes a topological data analysis on the coarse shape model stored in the shape data storage unit 121 and calculates a TDA vector indicating a geometry feature of the arrangement of the nodes included in the coarse shape model. In the second embodiment, the TDA execution unit 127 calculates a Betti number vector in which the Betti numbers corresponding to node radii are listed. The TDA execution unit 127 outputs the calculated TDA vector to the stress prediction unit 128.

The stress prediction unit 128 receives input of the fillet radius and the mesh size of the coarse shape model from the user. The stress prediction unit 128 generates, per corner detected by the corner detection unit 126, input data in which the fillet radius, the mesh size, the maximum stress, the stress ratio, and the TDA vector are combined. Next, the stress prediction unit 128 enters the input data to the neural network stored in the predictor storage unit 124. The stress prediction unit 128 outputs the fillet stress that has been predicted by the neural network, that is, the stress on a portion around a fillet that occurs if the corner is replaced by a fillet. For example, the stress prediction unit 128 stores the fillet stress in the HDD 103. In addition, for example, the stress prediction unit 128 displays the fillet stress on the display device 111. In addition, for example, the stress prediction unit 128 transmits the fillet stress to the terminal apparatus 31. The stress prediction unit 128 may synthesize the predicted fillet stress and a coarse simulation result about the portions other than the corner to generate and output a fine simulation result.

The machine learning server 200 includes a training data storage unit 221, a detector storage unit 222, and a predictor storage unit 223. These storage units are each implemented by using, for example, a storage area in a RAM or an HDD. In addition, the machine learning server 200 includes a detector learning unit 224, a predictor learning unit 225, and a TDA execution unit 226. These processing units are each implemented by using, for example, a program executed by a CPU.

The training data storage unit 221 holds training data for a convolutional neural network serving as a corner detector. The training data includes a plurality of samples, each of which includes a stress distribution in a small area, a corner flag, a maximum stress, and a stress ratio. The training data may be created by the terminal apparatus 31 and transferred to the machine learning server 200.

In addition, the training data storage unit 221 holds a coarse shape model having a smaller number of nodes. In addition, the training data storage unit 221 holds training data for a neural network serving as a predictor. The training data includes a plurality of samples, each of which includes a maximum stress, a stress ratio, a TDA vector, a mesh size, and a fillet radius. The TDA vector is generated from the coarse shape model through a topological data analysis in the machine learning server 200. Alternatively, the terminal apparatus 31 may perform the topological data analysis and transfer the generated TDA vector to the machine learning server 200. Still alternatively, the terminal apparatus 31 may also create other data items.

The detector storage unit 222 holds a convolutional neural network serving as a corner detector generated through machine learning. The generated convolutional neural network is provided to the simulation server 100. The predictor storage unit 223 holds a neural network serving as a predictor generated through machine learning. The generated neural network is provided to the simulation server 100.

The detector learning unit 224 generates a convolutional neural network serving as a corner detector through machine learning, based on the training data stored in the training data storage unit 221. In the machine learning, the values of parameters are determined through backpropagation, for example. The detector learning unit 224 stores the generated convolutional neural network in the detector storage unit 222.

The predictor learning unit 225 generates a neural network serving as a predictor through machine learning, based on the training data stored in the training data storage unit 221. In the machine learning, the values of parameters are determined through backpropagation, for example. The predictor learning unit 225 stores the generated neural network in the predictor storage unit 223.

The TDA execution unit 226 performs a topological data analysis on the coarse shape model stored in the training data storage unit 221 and calculates a TDA vector indicating a geometry feature of the arrangement of the nodes included in the coarse shape model. In the second embodiment, the TDA execution unit 226 calculates a Betti number vector in which the Betti numbers corresponding to node radii are listed.

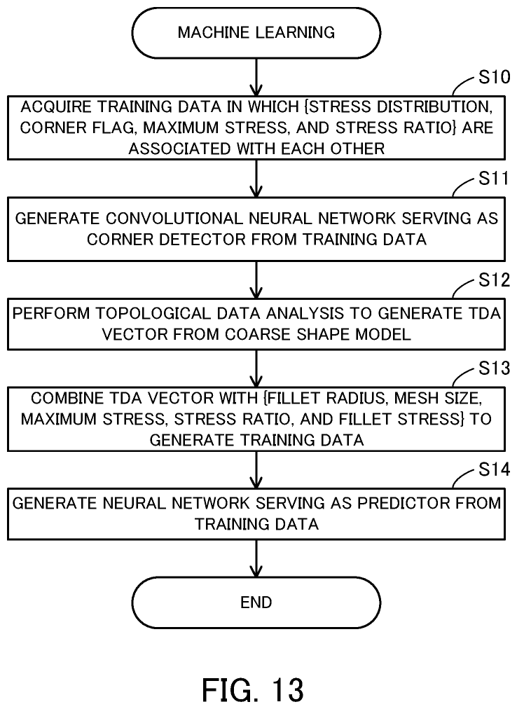

FIG. 13 is a flowchart illustrating an example of a procedure of machine learning.

(S10) The detector learning unit 224 acquires training data in which a stress distribution, a corner flag, a maximum stress, and a stress ratio are associated with each other.

(S11) The detector learning unit 224 performs machine learning by using the training data acquired in step S10, to generate a convolutional neural network serving as a corner detector.

(S12) The TDA execution unit 226 acquires a coarse shape model including a plurality of nodes and performs a topological data analysis to generate a TDA vector from the coarse shape model. For example, the TDA execution unit 226 calculates a Betti number vector in which Betti numbers corresponding to different radii are listed.

(S13) The predictor learning unit 225 acquires a fillet radius, a mesh size, a maximum stress, a stress ratio, and a fillet stress. The predictor learning unit 225 combines the acquired data with the TDA vector generated in step S12 to generate training data.

(S14) The predictor learning unit 225 performs machine learning by using the training data generated in step S13, to generate a neural network serving as a predictor.

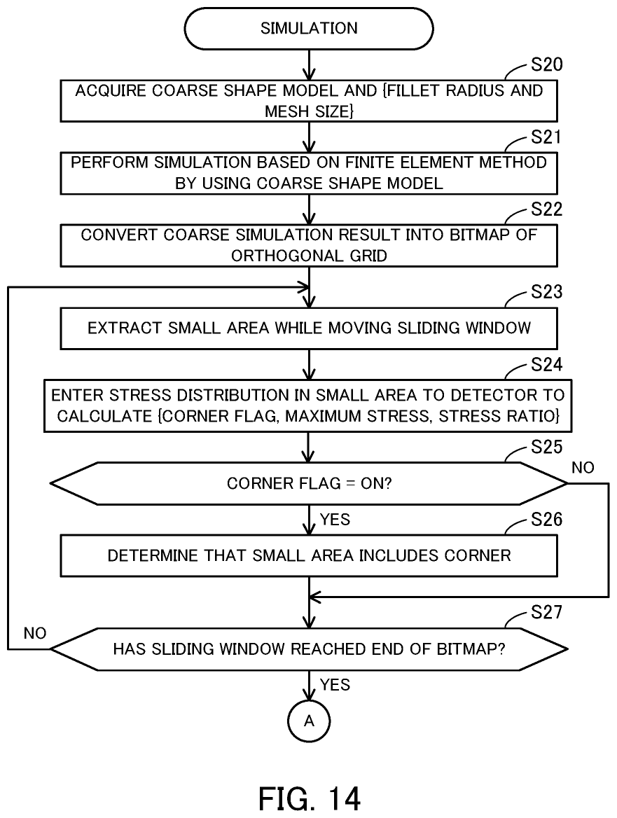

FIG. 14 is a flowchart illustrating an example of the first half of a procedure of a simulation.

(S20) The FEM execution unit 125 acquires a coarse shape model represented by mesh data including a plurality of nodes. In addition, the stress prediction unit 128 acquires a fillet radius and a mesh size, which have been specified by the user.

(S21) The FEM execution unit 125 performs a simulation based on a finite element method by using the coarse shape model, to generate a coarse simulation result. The coarse simulation result represents, for example, the stresses on the individual nodes of the coarse shape model.

(S22) The corner detection unit 126 converts the coarse simulation result generated in step S21 into a bitmap representing the stress on each grid point of an orthogonal grid. The stress at a grid point is estimated through linear interpolation from the stresses on its neighboring nodes.

(S23) While moving a sliding window on the bitmap generated in step S22, the corner detection unit 126 extracts a small area inside the sliding window from the bitmap. For example, the corner detection unit 126 moves the sliding window by a predetermined width from the top left corner to the bottom right corner of the bitmap.

(S24) The corner detection unit 126 enters a stress distribution in the small area extracted in step S23 to a convolutional neural network serving as a detector. The stress distribution in the small area is considered as a two-dimensional tensor corresponding to an image. The corner detection unit 126 calculates a corner flag, a maximum stress, and a stress ratio.

(S25) The corner detection unit 126 determines whether the corner flag calculated in step S24 represents ON(1). If the corner flag represents ON(1), the processing proceeds to step S26. If the corner flag represents OFF(0), the processing proceeds to step S27.

(S26) The corner detection unit 126 determines that the small area includes a corner. The corner detection unit 126 stores the maximum stress and the stress ratio calculated in step S24.

(S27) The corner detection unit 126 determines whether the sliding window has reached the end of the bitmap. If the sliding window has reached the end of the bitmap, the processing proceeds to step S28. If not, the processing returns to step S23.

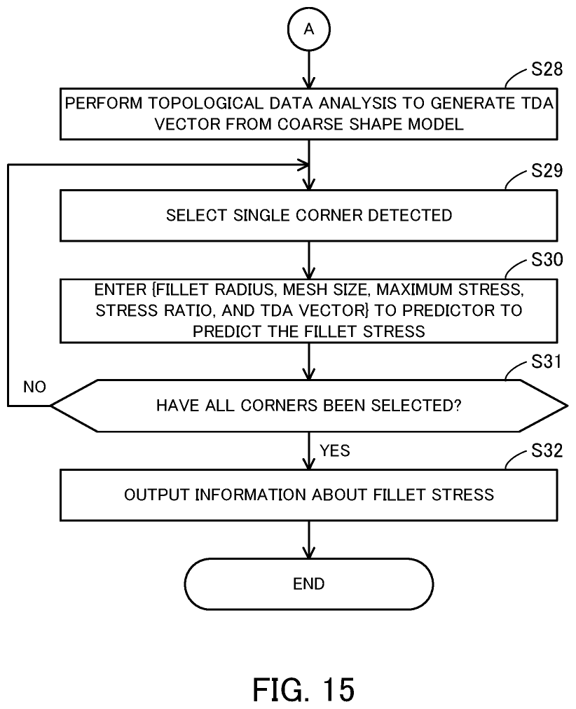

FIG. 15 is a flowchart illustrating an example of the second half of the procedure of the simulation.

(S28) The TDA execution unit 127 performs a topological data analysis to generate a TDA vector from the coarse shape model. For example, the TDA execution unit 127 calculates a Betti number vector in which the Betti numbers corresponding to different radii are listed.

(S29) The stress prediction unit 128 selects a single corner detected in step S26.

(S30) The stress prediction unit 128 combines the fillet radius and the mesh size acquired in step S20, the maximum stress and the stress ratio calculated in step S24 for the selected corner, and the TDA vector generated in step S28. As a result, input data, which is a vector, is generated. The stress prediction unit 128 enters the generated input data to a neural network serving as a predictor to predict the fillet stress.

(S31) The stress prediction unit 128 determines whether all the corners detected in step S26 have been selected. If all the corners have been selected, the processing proceeds to step S32. If there is still a corner not selected yet, the processing returns to step S29.

(S32) The stress prediction unit 128 outputs information about the predicted fillet stress. For example, the stress prediction unit 128 stores the fillet stress in the HDD 103. In addition, for example, the stress prediction unit 128 displays the fillet stress on the display device 111. In addition, for example, the stress prediction unit 128 transmits the fillet stress to the terminal apparatus 31.

Steps S28 to S32 may be implemented by using the following program modules as described below. The group of programs include a main program, a client program, a prediction program, and a shape analysis program. These program modules may be executed dispersively by using a plurality of calculation nodes.

First, the main program starts the client program and the shape analysis program. The main program calls the client program per corner and receives the calculated fillet stress from the client program. Upon receiving the fillet stresses of all the corners, the main program outputs the group of fillet stresses.

After called by the main program, the client program calls the shape analysis program and receives a TDA vector from the shape analysis program. The client program calls the prediction program by using the fillet radius and the mesh size specified by the user, the maximum stress and the stress ratio of the corner selected by the main program, and the TDA vector as parameters. The client program receives a fillet stress from the prediction program and transmits the fillet stress to the main program.

After called by the client program, the prediction program enters the fillet radius, the mesh size, the maximum stress, the stress ratio, and the TDA vector to a neural network to predict a fillet stress. The prediction program transmits the fillet stress to the client program. The shape analysis program performs a topological data analysis on the entire finite element model to calculate a TDA vector. After called by the client program, the shape analysis program transmits the TDA vector to the client program.

Next, the simulation speed will be described.

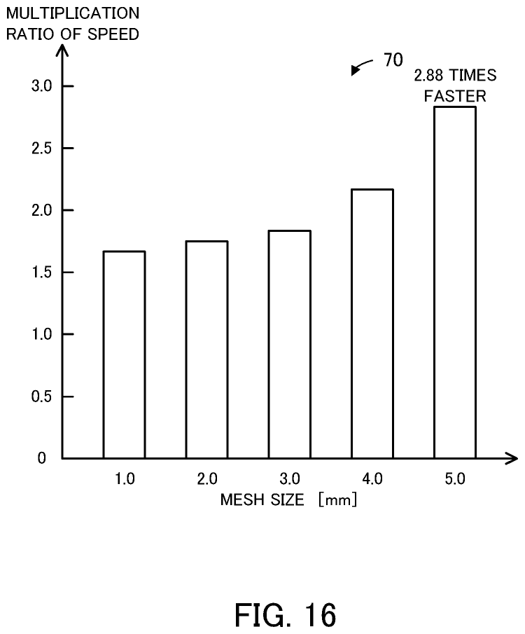

FIG. 16 is a graph illustrating an example of improvement in the speed of the simulation.

The horizontal axis of a graph 70 represents the mesh size of a coarse shape model. The vertical axis of the graph 70 represents the multiplication ratio of the speed. The numerator of the multiplication ratio of the speed is the execution time of a simulation based on a finite element method using a fine shape model. The denominator of the multiplication ratio of the speed is a sum of the execution time of a simulation based on a finite element method using a coarse shape model and the execution time of the fillet stress prediction using a neural network. That is, the multiplication ratio of the speed is the ratio between the execution time according to a conventional method and the execution time according to the prediction method. A larger multiplication ratio signifies a larger execution time reduction effect.

As illustrated in the graph 70, when the mesh size is 1 mm, the prediction method achieves the speed about 1.7 times faster than that of the conventional method. When the mesh size is 2 mm, the prediction method achieves the speed about 1.8 times faster than that of the conventional method. When the mesh size is 3 mm, the prediction method achieves the speed about 1.9 times faster than that of the conventional method. When the mesh size is 4 mm, the prediction method achieves the speed about 2.2 times faster than that of the conventional method. When the mesh size is 5 mm, the prediction method achieves the speed about 2.88 times faster than that of the conventional method. Thus, the speed according to the prediction method is faster than that according to the conventional method, and the execution time according to the prediction method is shorter than that according to the conventional method. In addition, coarse shape data having a larger mesh size achieves a faster speed.

With the simulation system according to the second embodiment, a corner stress is calculated from a coarse shape model having a small number of nodes, and a fillet stress is predicted by using a neural network. In this way, compared with a case where a fillet stress is directly calculated from a fine shape model having many nodes, the burden of generating a fine shape model is reduced. In addition, since the calculation amount of the structural analysis simulation is reduced, the execution time is shortened.

In addition, a corner is detected from a stress distribution of a coarse shape model by using a sliding window and a learned convolutional neural network, and the maximum stress and the stress ratio of an individual corner are automatically extracted. In addition, a topological data analysis is performed on the coarse shape model, and a TDA vector reflecting geometry features such as corner angles is calculated. As a result, since the user does not need create input data manually per corner, fillet stresses are predicted more efficiently. In addition, since a TDA vector appropriately reflecting the geometry features is included in the input data, the prediction accuracy of the neural network is improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
acquiring mesh data representing a shape of an object with a plurality of nodes and result data representing a physical amount of the object, the physical amount having been calculated based on the mesh data;
calculating a first feature amount representing a feature of a positional relationship of the plurality of nodes by performing a topological data analysis on the plurality of nodes included in the mesh data; and
predicting a physical amount calculated from the shape of the object represented with more nodes than the nodes of the mesh data by entering the first feature amount and a second feature amount based on the physical amount represented by the result data to a learned model.

2. The non-transitory computer-readable recording medium according to claim 1, wherein the first feature amount is represented as a feature vector in which a radius of a node and a Betti number are associated with each other.

3. The non-transitory computer-readable recording medium according to claim 1, wherein the process further includes generating a bitmap representing physical amounts at a plurality of locations in a grid based on the result data, extracting an area from the bitmap with a sliding window, entering a distribution of physical amounts included in the area to a different learned model, to detect the second feature amount.

4. The non-transitory computer-readable recording medium according to claim 1, wherein the predicting of the physical amount includes receiving a third feature amount representing a feature of the shape of the object, the feature not represented by the mesh data, and additionally entering the third feature amount to the learned model.

5. The non-transitory computer-readable recording medium according to claim 1,
wherein the physical amount indicates a stress on a corner included in the object, and the mesh data represents the corner as a sharp shape, which does not include a fillet, and
wherein the predicting of the physical amount includes predicting a stress on a fillet used for the corner.

6. The non-transitory computer-readable recording medium according to claim 1, wherein the process further includes calculating a different first feature amount by performing the topological data analysis on different mesh data, generating training data including the different first feature amount, a different second feature amount, and teaching data representing a physical amount calculated from more nodes than those of the different mesh data, and generating the learned model by using the training data.

7. A simulation method comprising:
acquiring, by a processor, mesh data representing a shape of an object with a plurality of nodes and result data representing a physical amount of the object, the physical amount having been calculated based on the mesh data;
calculating, by the processor, a first feature amount representing a feature of a positional relationship of the plurality of nodes by performing a topological data analysis on the plurality of nodes included in the mesh data; and
predicting, by the processor, a physical amount calculated from the shape of the object represented with more nodes than the nodes of the mesh data by entering the first feature amount and a second feature amount based on the physical amount represented by the result data to a learned model.

8. A simulation system comprising:
a memory configured to store mesh data representing a shape of an object with a plurality of nodes and result data representing a physical amount of the object, the physical amount having been calculated based on the mesh data; and
a processor configured to calculate a first feature amount representing a feature of a positional relationship of the plurality of nodes by performing a topological data analysis on the plurality of nodes included in the mesh data and predict a physical amount calculated from the shape of the object represented with more nodes than the nodes of the mesh data by entering the first feature amount and a second feature amount based on the physical amount represented by the result data to a learned model.
